(19) United States
(12) Patent Application Publication
(10) Pub. No.: US 2026/0311980 A1
(43) Pub. Date: Oct. 8, 2026

(54) METHOD FOR CHARGE CALIBRATION OF CDMS MEASUREMENTS OF CHARGED PARTICLES

(71) Applicant: THE TRUSTEES OF INDIANA UNIVERSITY, Bloomington, IN (US)

(72) Inventor: Martin F. JARROLD, Bloomington, IN (US)

(21) Appl. No.: 19/566,624

(22) Filed: Mar. 13, 2026

Related U.S. Application Data
(60) Provisional application No. 63/784,541, filed on Apr. 7, 2025.

(51) Int. Cl. H01J 49/00; H01J 49/16; H01J 49/28

(52) U.S. Cl. CPC H01J 49/0009; H01J 49/0031; H01J 49/165; H01J 49/282

(57) ABSTRACT

A method of calibrating charge values of charged particles to be measured by a CDMS having a charge detection cylinder, a charge sensitive amplifier to detect charges induced on the charge detection cylinder, and an antenna, may include applying a constant amplitude, variable frequency signal to the antenna to induce respectively constant amplitude charges on the charge detection cylinder over a range of frequencies, and processing charge detection signals produced by the charge sensitive amplifier in response to detection of the constant amplitude charges induced on the charge detection cylinder over the range of frequencies to determine a frequency-dependent correction factor to apply to and calibrate the charge values of charged particles to be measured by the CDMS. Alternatively or additionally, the method may include determining an alignment correction factor to align the measured charge values with integer charge values.

### CROSS-REFERENCE TO RELATED APPLICATION

This patent application claims the benefit of and priority to U.S. Provisional Patent Application Ser. No. 63/784,451, filed Apr. 7, 2025, the disclosure of which is incorporated herein by reference in its entirety.

### GOVERNMENT RIGHTS

This invention was made with government support under GM131100 awarded by the National Institutes of Health. The United States Government has certain rights in the invention.

### TECHNICAL FIELD

The present disclosure relates generally to charge detection mass spectrometers, and more specifically to apparatuses and methods for charge calibration of CDMS measurements of charged particles.

### BACKGROUND

Mass Spectrometry provides for the identification of chemical components of a substance by separating gaseous ions of the substance according to ion mass and charge. Various instruments and techniques have been developed for determining the masses of such separated ions, and one such technique is known as charge detection mass spectrometry (CDMS). In CDMS, ion mass is determined as a function of measured ion mass-to-charge ratio, typically referred to as “m/z,” and measured ion charge. It is desirable to calibrate charge measurements made with CDMS measurements to compensate for hardware and signal processing variability.

### SUMMARY

The present disclosure may comprise one or more of the features recited in the attached claims, and/or one or more of the following features and combinations thereof. In a first aspect, a method is provided for calibrating charge values of charged particles to be measured by charge detection mass spectrometer, wherein the charge detection mass spectrometer includes a charge detection cylinder, a charge sensitive amplifier to detect charges induced on the charge detection cylinder, and at least one antenna for inducing charges on the charge detection cylinder. The method may comprise applying a constant amplitude, variable frequency signal to the at least one antenna to induce respectively constant amplitude charges on the charge detection cylinder over a range of frequencies, and processing charge detection signals produced by the charge sensitive amplifier in response to detection of the constant amplitude charges induced on the charge detection cylinder over the range of frequencies to determine a frequency-dependent correction factor to apply to and calibrate the charge values of charged particles to be measured by the charge detection mass spectrometer.

A second aspect includes the features of the first aspect, wherein the charge detection mass spectrometer includes a charged particle generator to generate charged particles from a sample, and wherein the method further comprises measuring, with the charge detection mass spectrometer, mass-to-charge and charge values of charges induced on the charge detection cylinder by charged particles generated by the charged particle generator from a number of different sample species, and processing charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

A third aspect includes the features of the first aspect or the second aspect, and wherein the method further comprises, prior to applying the constant amplitude, variable frequency signal to the at least one antenna, applying a constant amplitude, fixed frequency signal to the at least one antenna to induce respectively constant amplitude, fixed frequency charges on the charge detection cylinder, and processing charge detection signals produced by the charge sensitive amplifier in response to detection of the constant amplitude, fixed frequency charges induced on the charge detection cylinder to determine a magnitude correction factor to apply to and calibrate the charge values of charged particles to be measured by the charge detection mass spectrometer.

A fourth aspect includes the features of the third aspect, wherein the method may further comprise, prior to determining the frequency-dependent correction factor, correcting magnitudes of the charge detection signals produced by the charge sensitive amplifier in response to detection of the constant amplitude charges induced on the charge detection cylinder over the range of frequencies using the magnitude correction factor.

A fifth aspect includes the features of any of the second through fourth aspects, and wherein the alignment correction factor includes a linear correction component dependent on the measured mass-to-charge and charge values of the charged particles for the number of different sample species, and an offset correction component.

A sixth aspect includes the features of the fifth aspect, and wherein the offset correction component is a constant.

A seventh aspect includes the features of the fifth aspect, and may further comprise applying a constant frequency, variable amplitude signal to the at least one antenna to induce respectively constant frequency charges on the charge detection cylinder over a range of amplitudes, and processing charge detection signals produced by the charge sensitive amplifier in response to detection of the constant frequency charges induced on the charge detection cylinder over the range of amplitudes to determine the offset correction component in the form of an amplitude-dependent correction factor.

In an eighth aspect, a method is providing for calibrating charge values of charged particles to be measured by charge detection mass spectrometer, wherein the charge detection mass spectrometer includes a charged particle generator to generate charged particles from a sample, a charge detection cylinder, and a charge sensitive amplifier to detect charges induced on the charge detection cylinder. The method may comprise measuring, with the charge detection mass spectrometer, mass-to-charge and charge values of charges induced on the charge detection cylinder by charged particles generated by the charged particle generator from a number of different sample species, and processing charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

A ninth aspect includes the features of the eighth aspect, and wherein the alignment correction factor includes a linear correction component dependent on the measured mass-to-charge and charge values of the charged particles for the number of different sample species, and an offset correction component.

A tenth aspect includes the features of the ninth aspect, and wherein the offset correction component is a constant.

An eleventh aspect includes the features of the ninth aspect, wherein the charge detection mass spectrometer includes at least one antenna for inducing charges on the charge detection cylinder, and wherein the metho further comprises applying a constant frequency, variable amplitude signal to the at least one antenna to induce respectively constant frequency charges on the charge detection cylinder over a range of amplitudes, and processing charge detection signals produced by the charge sensitive amplifier in response to detection of the constant frequency charges induced on the charge detection cylinder over the range of amplitudes to determine the offset correction component in the form of an amplitude-dependent correction factor.

In a twelfth aspect, a charge detection mass spectrometer comprises an electrostatic linear ion trap (ELIT) or an orbitrap, including a charge detection cylinder, a charge sensitive amplifier configured to detect charges induced on the charge detection cylinder, at least one antenna for inducing charges on the charge detection cylinder, at least one voltage source, at least one memory, and at least one processor configured to execute instructions stored in the at least one memory to cause the at least one processor to calibrate charge values of charged particles to be measured by the charge detection mass spectrometer by (i) controlling the at least one voltage source to apply a constant amplitude, variable frequency signal to the at least one antenna to induce respectively constant amplitude charges on the charge detection cylinder over a range of frequencies, and (ii) processing charge detection signals produced by the charge sensitive amplifier in response to detection of the constant amplitude charges induced on the charge detection cylinder over the range of frequencies to determine a frequency-dependent correction factor to apply to and calibrate the charge values of charged particles measured by the charge detection mass spectrometer.

A thirteenth aspect includes the features of the twelfth aspect, and further comprises a charged particle generator to generate charged particles and to supply the generated charged particles to the ELIT or orbitrap, and wherein the instructions stored in the memory include instructions executable by the at least one processor to cause the at least one processor to (iii) control the charge detection mass spectrometer to measure mass-to-charge and charge values of charges induced on the charge detection cylinder by charged particles generated by the charged particle generator from a number of different sample species, and (iv) to process charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

A fourteenth aspect includes the features of the twelfth aspect or the thirteenth aspect, and wherein the instructions stored in the memory further include instructions executable by the at least one processor to cause the at least one processor to, prior to controlling the at least one voltage source to apply the constant amplitude, variable frequency signal to the at least one antenna, (v) control the at least one voltage source to apply to the at least one antenna a constant amplitude, fixed frequency signal to the at least one antenna to induce respectively constant amplitude, fixed frequency charges on the charge detection cylinder, and (vi) process charge detection signals produced by the charge sensitive amplifier in response to detection of the constant amplitude, fixed frequency charges induced on the charge detection cylinder to determine a magnitude correction factor to apply to and calibrate the charge values of charged particles to be measured by the charge detection mass spectrometer.

A fifteenth aspect includes the features of the fourteenth aspect, and wherein the instructions stored in the memory further include instructions executable by the at least one processor to cause the at least one processor to, prior to determining the frequency-dependent correction factor, correct magnitudes of the charge detection signals produced by the charge sensitive amplifier in response to detection of the constant amplitude charges induced on the charge detection cylinder over the range of frequencies using the magnitude correction factor.

A sixteenth aspect includes the features of any of the thirteenth through fifteenth aspects, and wherein the alignment correction factor comprises a linear correction component dependent on the measured mass-to-charge and charge values of the charged particles for the number of different sample species, and an offset correction component, and wherein (vii) the offset correction component is a constant, or (viii) the instructions stored in the memory further include instructions executable by the at least one processor to cause the at least one processor to (ix) control the at least one voltage source to apply a constant frequency, variable amplitude signal to the at least one antenna to induce respectively constant frequency charges on the charge detection cylinder over a range of amplitudes, and (x) process charge detection signals produced by the charge sensitive amplifier in response to detection of the constant frequency charges induced on the charge detection cylinder over the range of amplitudes to determine the offset correction component in the form of an amplitude-dependent correction factor.

A seventeenth aspect includes the features of any of the thirteenth through sixteenth aspects, and further comprises at least one ion processing stage positioned between the charged particle generator and the ELIT or orbitrap.

An eighteenth aspect includes the features of any of the thirteenth through seventeenth aspects, and wherein the charged particle generator is an electrospray ionization source.

In a nineteenth aspect, a charge detection mass spectrometer comprises an electrostatic linear ion trap (ELIT) or an orbitrap, including a charge detection cylinder, a charged particle generator to generate charged particles and to supply the generated charged particles to the ELIT or orbitrap, at least one memory, and at least one processor configured to execute instructions stored in the at least one memory to cause the at least one processor to calibrate charge values of charged particles to be measured by the charge detection mass spectrometer by (i) controlling the charge detection mass spectrometer to measure mass-to-charge and charge values of charges induced on the charge detection cylinder by charged particles generated by the charged particle generator from a number of different sample species, and (ii) to process charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

A twentieth aspect includes the features of the nineteenth aspect, and further comprises a charge sensitive amplifier configured to detect charges induced on the charge detection cylinder, at least one antenna for inducing charges on the charge detection cylinder, and at least one voltage source, and wherein the alignment correction factor comprises a linear correction component dependent on the measured mass-to-charge and charge values of the charged particles for the number of different sample species, and an offset correction component, and wherein (iii) the offset correction component is a constant, or (iv) the instructions stored in the memory further include instructions executable by the at least one processor to cause the at least one processor to (v) control the at least one voltage source to apply a constant frequency, variable amplitude signal to the at least one antenna to induce respectively constant frequency charges on the charge detection cylinder over a range of amplitudes, and (vi) process charge detection signals produced by the charge sensitive amplifier in response to detection of the constant frequency charges induced on the charge detection cylinder over the range of amplitudes to determine the offset correction component in the form of an amplitude-dependent correction factor.

### BRIEF DESCRIPTION OF THE DRAWINGS

FIG. 1 is a simplified diagram of a charge detection mass spectrometer (CDMS) including an electrostatic linear ion trap (ELIT) with control and measurement components coupled thereto, and including control components for calibrating charge measurements made using the CDMS.

FIG. 2A is a magnified view of the ion mirror M1 of the ELIT illustrated in FIG. 1 in which the mirror electrodes of M1 are controlled to produce an ion transmission electric field therein.

FIG. 2B is a magnified view of the ion mirror M2 of the ELIT illustrated in FIG. 1 in which the mirror electrodes of M2 are controlled to produce an ion reflection electric field therein.

FIG. 3A is a plot of inexact charge against frequency generated by applying a square wave to one of the antennas depicted in FIG. 1.

FIG. 3B is a plot of a frequency correction factor derived from the data depicted in FIG. 3A.

FIG. 4A is a plot of measured charge distributions for mAb MSQC4.

FIG. 4B is a plot of adjusted charge distributions for mAb MSQC4.

FIG. 4C is a plot of calibrated charge distributions for mAb MSQC4.

FIG. 5A is a plot of a measured mass distribution for GDH, including measured monomer, dimer, and trimer mass distributions.

FIG. 5B is a plot of a calibrated mass distribution for GDH, including calibrated monomer, dimer, and trimer mass distributions.

FIG. 6 is a plot of offset intercepts determined from measurements as a function of frequency plotted against m/z, and also showing a polynomial fit to the measurements.

FIG. 7 is a schematic diagram illustrating the calibration of frequency-dependent noise offset and frequency response for an Orbitrap DMT method of analyzing single ions.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to operation of a charge detection mass spectrometer (CDMS) including an electrostatic linear ion trap (ELIT), and to apparatuses and methods for charge calibration of charged particles measured by the CDMS; i.e., to apparatuses and methods for calibrating charge values of the charged particles measured by the CDMS. For purposes of this disclosure, the phrase “charge detection event” is defined as detection of a charge associated with an ion passing a single time through the charge detector in the ELIT, and the phrase “ion measurement event” is defined as a collection of charge detection events resulting from oscillation of an ion back and forth through the charge detector a selected number of times or for a selected time period.

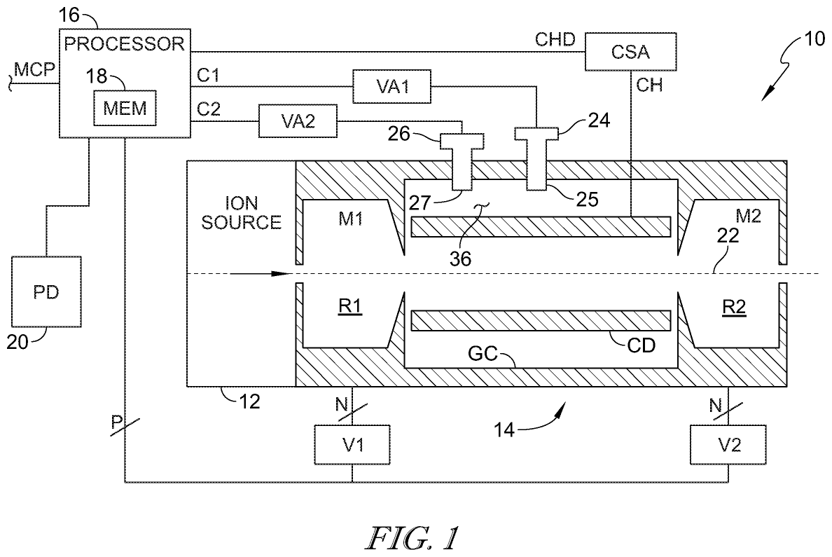

Referring to FIG. 1, a charge detection mass spectrometer (CDMS) 10 is shown including an embodiment of an electrostatic linear ion trap (ELIT) 14 with control and measurement components coupled thereto and including control components for calibrating charge measurements made using the CDMS 10. In the illustrated embodiment, the CDMS 10 includes an ion source 12 operatively coupled to an inlet of the ELIT 14. The ion source 12 illustratively is or includes any conventional device or apparatus for generating ions from a sample, and may further include one or more ion processing stages in the form of one or more conventional devices and/or instruments for guiding the generated ions and/or for separating, collecting, filtering, fragmenting and/or normalizing the generated ions according to one or more molecular characteristics. By way of example, which should not be considered to be limiting in any way, the apparatus for generating ions from a sample may be or include a conventional electrospray ionization source, a matrix-assisted laser desorption ionization (MALDI) source or the like. In embodiments in which the ion source 12 includes one or more ion processing stages in the form of one or more devices and/or instruments for guiding the generated ions, such one or more devices and/or instruments may be or include one or more conventional quadrupole, hexapole, and/or other conventional ion guiding instrument and/or device. In embodiments which the ion source 12 includes one or more ion processing stages in the form of one or more instruments for separating the generated ions according to one or more molecular characteristics, the one or more instruments for separating ions may be or include one or more instruments or apparatuses for separating ions in solution prior to ionization and/or one or more instruments or apparatuses for separating ions after ionization. In the former case, the one or more instruments or apparatuses may be or include at least one of a conventional liquid chromatograph, a size exclusion chromatograph (SEC), or the like, and in the latter case the one or more instruments or apparatuses may be or include at least one of a conventional ion mobility spectrometer, a mass spectrometer or mass analyzer, or the like. In embodiments in which the one or more instruments or apparatuses include at least one mass spectrometer, the at least one mass spectrometer may be of any conventional design including, for example, but not limited to a time-of-flight (TOF) mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, or the like. In any case, the ion outlet of the mass spectrometer is, in this particular example, the outlet of the ion source 12 and is operatively coupled to an ion inlet of the ELIT 14 as depicted by example in FIG. 1. The sample from which the ions are generated may be any biological or other material.

In the illustrated embodiment, the ELIT 14 illustratively includes a charge detector CD surrounded by a ground shield or cylinder GC and operatively coupled to opposing ion mirrors M1, M2 respectively positioned at opposite ends thereof. The ion mirror M1 is operatively positioned between the ion source 12 and one end of the charge detector CD, and ion mirror M2 is operatively positioned at the opposite end of the charge detector CD. Each ion mirror M1, M2 defines a respective ion mirror region R1, R2 therein. The regions R1, R2 of the ion mirrors M1, M2, the charge detector CD, and the spaces between the charge detector CD and the ion mirrors M1, M2 together define a longitudinal axis 22 centrally therethrough which illustratively represents an ideal ion travel path through the ELIT 14 and between the ion mirrors M1, M2 as will be described in greater detail below.

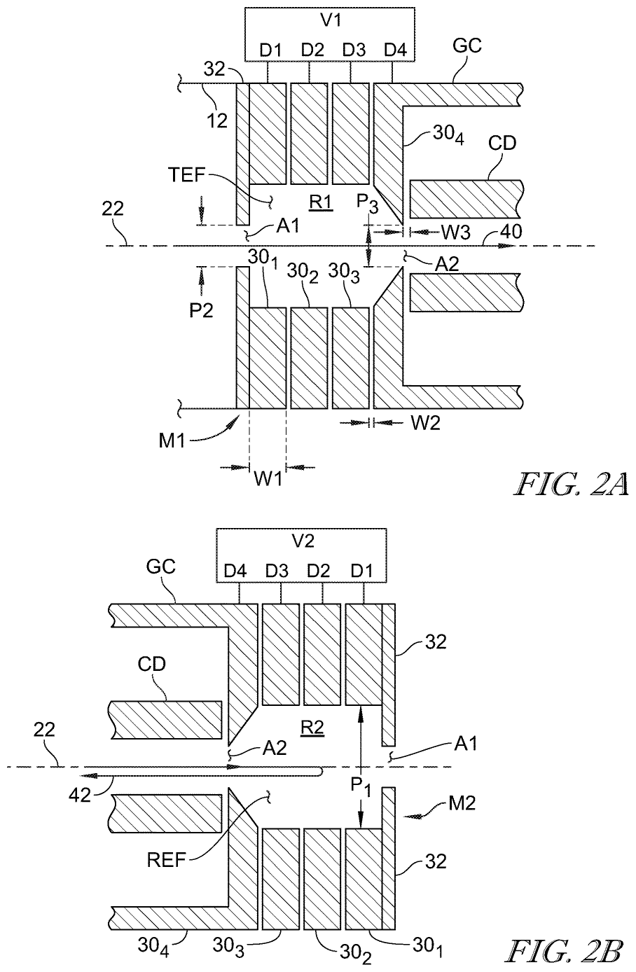

In the illustrated embodiment, voltage sources V1, V2 are electrically connected to the ion mirrors M1, M2 respectively. Each voltage source V1, V2 illustratively includes one or more switchable DC voltage sources which may be controlled or programmed to selectively produce a number, N, programmable or controllable voltages, wherein N may be any positive integer. Illustrative examples of such voltages will be described below with respect to FIGS. 2A and 2B to establish one of two different operating modes of each of the ion mirrors M1, M2 as will be described in detail below. In any case, ions move within the ELIT 14 along the longitudinal axis 22 extending centrally through the charge detector CD and the ion mirrors M1, M2 under the influence of electric fields selectively established by the voltage sources V1, V2.

The voltage sources V1, V2 are illustratively shown electrically connected by a number, P, of signal paths to a conventional processor 16 including a memory 18 having instructions stored therein which, when executed by the processor 16, cause the processor 16 to control the voltage sources V1, V2 to produce desired DC output voltages for selectively establishing ion transmission and ion reflection electric fields, TEF, REF respectively, within the regions R1, R2 of the respective ion mirrors M1, M2. P may be any positive integer. In some alternate embodiments, either or both of the voltage sources V1, V2 may be programmable to selectively produce one or more constant output voltages. In other alternative embodiments, either or both of the voltage sources V1, V2 may be configured to produce one or more time-varying output voltages of any desired shape. It will be understood that more or fewer voltage sources may be electrically connected to the mirrors M1, M2 in alternate embodiments.

The charge detector CD is illustratively provided in the form of an electrically conductive cylinder which is electrically connected to a signal input of a charge sensitive amplifier CSA, and the signal output of the charge sensitive amplifier CSA is electrically connected to the processor 16. The charge sensitive amplifier CSA is illustratively operable in a conventional manner to receive a charge signal (CH) corresponding to a charge induced on the charge detection cylinder CD by one or more ions passing therethrough, to produce a charge detection signal (CHD) corresponding thereto and to supply the charge detection signal CHD to the processor 16. In some embodiments, the sensitive amplifier CSA may include conventional feedback components, e.g., one or more resistors and/or other conventional feedback circuitry, coupled between the output and at least one of the inputs thereof. In some alternate embodiments, the charge sensitive amplifier CSA may not include any resistive feedback components, and in still other alternate embodiments the charge sensitive amplifier CSA may not include any feedback components at all. In any case, the processor 16 is, in turn, illustratively operable to receive and digitize charge detection signals CHD produced by the charge sensitive amplifier CSA, and to store the digitized charge detection signals CHD in the memory 18. The processor 16 is further illustratively coupled to one or more peripheral devices 20 (PD) for providing signal input(s) to the processor 16 and/or to which the processor 16 provides signal output(s). In some embodiments, the peripheral devices 20 include at least one of a conventional display monitor, a printer and/or other output device, and in such embodiments the memory 18 has instructions stored therein which, when executed by the processor 16, cause the processor 16 to control one or more such output peripheral devices 20 to display and/or record analyses of the stored, digitized charge detection signals.

The voltage sources V1, V2 are illustratively controlled in a manner, as described in detail below, which selectively traps an ion entering the ELIT 14 and causes the trapped ion to oscillate back and forth between the ion mirrors M1, M2 such that it repeatedly passes through the charge detection cylinder CD. A plurality of charge and oscillation period values are measured at the charge detection cylinder CD, and the recorded results are processed to determine mass-to-charge ratio, charge and mass values of the ion trapped in the ELIT 14.

Referring now to FIGS. 2A and 2B, embodiments are shown of the ion mirrors M1, M2 respectively of the ELIT 14 depicted in FIG. 1. Illustratively, the ion mirrors M1, M2 are identical to one another in that each includes a cascaded arrangement of 4 spaced-apart, electrically conductive mirror electrodes. For each of the ion mirrors M1, M2, a first mirror electrode 30₁ has a thickness W1 and defines a passageway centrally therethrough of diameter P1. An endcap 32 is affixed or otherwise coupled to an outer surface of the first mirror electrode 30₁ and defines an aperture A1 centrally therethrough which serves as an ion entrance and/or exit to and/or from the corresponding ion mirror M1, M2 respectively. In the case of the ion mirror M1, the endcap 32 is coupled to, or is part of, an ion exit of the ion source 12 illustrated in FIG. 1. The aperture A1 for each endcap 32 illustratively has a diameter P2.

A second mirror electrode 30₂ of each ion mirror M1, M2 is spaced apart from the first mirror electrode 30₁ by a space having width W2. The second mirror electrode 30₂, like the mirror electrode 30₁, has thickness W1 and defines a passageway centrally therethrough of diameter P2. A third mirror electrode 30₃ of each ion mirror M1, M2 is likewise spaced apart from the second mirror electrode 30₂ by a space of width W2. The third mirror electrode 30₂ has thickness W1 and defines a passageway centrally therethrough of width P1.

A fourth mirror electrode 30₄ is spaced apart from the third mirror electrode 30₃ by a space of width W2. The fourth mirror electrode 30₄ illustratively has a thickness of W1 and is formed by a respective end of the ground cylinder, GC disposed about the charge detector CD. The fourth mirror electrode 30₄ defines an aperture A2 centrally therethrough which is illustratively conical in shape and increases linearly between the internal and external faces of the ground cylinder GC from a diameter P3 defined at the internal face of the ground cylinder GC to the diameter P1 at the external face of the ground cylinder GC (which is also the internal face of the respective ion mirror M1, M2).

The spaces defined between the mirror electrodes 30₁-30₄ may be voids in some embodiments, i.e., vacuum gaps, and in other embodiments such spaces may be filled with one or more electrically non-conductive, e.g., dielectric, materials. The mirror electrodes 30₁-30₄ and the endcaps 32 are axially aligned, i.e., collinear, such that a longitudinal axis 22 passes centrally through each aligned passageway and also centrally through the apertures A1, A2. In embodiments in which the spaces between the mirror electrodes 30₁-30₄ include one or more electrically non-conductive materials, such materials will likewise define respective passageways therethrough which are axially aligned, i.e., collinear, with the passageways defined through the mirror electrodes 30₁-30₄ and which illustratively have diameters of P2 or greater. Illustratively, P1>P3>P2, although in other embodiments other relative diameter arrangements are possible. A region R1 is defined between the apertures A1, A2 of the ion mirror M1, and another region R2 is likewise defined between the apertures A1, A2 of the ion mirror M2. The regions R1, R2 are illustratively identical to one another in shape and in volume.

As described above, the charge detector CD is illustratively provided in the form of an elongated, electrically conductive cylinder positioned and spaced apart between corresponding ones of the ion mirrors M1, M2 by a space of width W3. In one embodiment, W1>W3>W2, and P1>P3>P2, although in alternate embodiments other relative width arrangements are possible. In any case, the longitudinal axis 22 illustratively extends centrally through the passageway defined through the charge detection cylinder CD, such that the longitudinal axis 22 extends centrally through the combination of the passageways defined by the regions R1, R2 of the ion mirrors M1, M2 and the passageway defined through the charge detection cylinder CD. In operation, the ground cylinder GC is illustratively controlled to ground potential such that the fourth mirror electrode 304 of each ion mirror M1, M2 is at ground potential at all times. In some alternate embodiments, the fourth mirror electrode 304 of either or both of the ion mirrors M1, M2 may be set to any desired DC reference potential, or to a switchable DC or other time-varying voltage source.

In the embodiment illustrated in FIGS. 2A and 2B, the voltage sources V1, V2 are each configured to each produce four DC voltages D1-D4, and to supply the voltages D1-D4 to a respective one of the mirror electrodes 30₁-30₄ of the respective ion mirror M1, M2. In some embodiments in which one or more of the mirror electrodes 30₁-30₄ is to be held at ground potential at all times, the one or more such mirror electrodes 30₁-30₄ may alternatively be electrically connected to the ground reference of the respective voltage supply V1, V2 and the corresponding one or more voltage outputs D1-D4 may be omitted. Alternatively or additionally, in embodiments in which any two or more of the mirror electrodes 30₁-30₄ are to be controlled to the same non-zero DC values, any such two or more mirror electrodes 30₁-30₄ may be electrically connected to a single one of the voltage outputs D1-D4 and superfluous ones of the output voltages D1-D4 may be omitted.

Each ion mirror M1, M2 is illustratively controllable and switchable, by selective application of the voltages D1-D4, between an ion transmission mode (FIG. 2A) in which the voltages D1-D4 produced by the respective voltage source V1, V2 establishes an ion transmission electric field (TEF) in the respective region R1, R2 thereof, and an ion reflection mode (FIG. 2B) in which the voltages D1-D4 produced by the respect voltage source V1, V2 establishes an ion reflection electric field (REF) in the respective region R1, R2 thereof. As illustrated by example in FIG. 2A, once an ion from the ion source 12 flies into the region R1 of the ion mirror M1 through the inlet aperture A1 of the ion mirror M1, the ion is focused toward the longitudinal axis 22 of the ELIT 14 by an ion transmission electric field TEF established in the region R1 of the ion mirror M1 via selective control of the voltages D1-D4 of V1. As a result of the focusing effect of the transmission electric field TEF in the region R1 of the ion mirror M1, the ion exiting the region R1 of the ion mirror M1 through the aperture A2 of the ground chamber GC attains a narrow trajectory into and through the charge detector CD, i.e., so as to maintain a path of ion travel through the charge detector CD that is close to the longitudinal axis 22. An identical ion transmission electric field TEF may be selectively established within the region R2 of the ion mirror M2 via like control of the voltages D1-D4 of the voltage source V2. In the ion transmission mode, an ion entering the region R2 from the charge detection cylinder CD via the aperture A2 of M2 is focused toward the longitudinal axis 22 by the ion transmission electric field TEF within the region R2 so that the ion exits the ion mirror M2 through the aperture A1 thereof.

As illustrated by example in FIG. 2B, an ion reflection electric field REF established in the region R2 of the ion mirror M2 via selective control of the voltages D1-D4 of V2 acts to decelerate and stop an ion entering the ion region R2 from the charge detection cylinder CD via the ion inlet aperture A2 of M2, to accelerate the ion in the opposite direction back through the aperture A2 of M2 and into the end of the charge detection cylinder CD adjacent to M2 as depicted by the ion trajectory 42, and to focus the ion toward the central, longitudinal axis 22 within the region R2 of the ion mirror M2 so as to maintain a narrow trajectory of the ion back through the charge detector CD toward the ion mirror M1. An identical ion reflection electric field REF may be selectively established within the region R1 of the ion mirror M1 via like control of the voltages D1-D4 of the voltage source V1. In the ion reflection mode, an ion entering the region R1 from the charge detection cylinder CD via the aperture A2 of M1 is decelerated and stopped by the ion reflection electric field REF established within the region R1, then accelerated in the opposite direction back through the aperture A2 of M1 and into the end of the charge detection cylinder CD adjacent to M1, and focused toward the central, longitudinal axis 22 within the region R1 of the ion mirror M1 so as to maintain a narrow trajectory of the ion back through the charge detector CD and toward the ion mirror M2. An ion that traverses the length of the ELIT 14 and is reflected by the ion reflection electric field REF in the ion regions R1, R2 in a manner that enables the ion to continue traveling back and forth through the charge detection cylinder CD between the ion mirrors M1, M2 as just described is considered to be trapped within the ELIT 14.

Example sets of output voltages D1-D4 produced by the voltage sources V1, V2 respectively to control a respective one of the ion mirrors M1, M2 to the ion transmission and reflection modes described above are shown in TABLE I below. It will be understood that the following values of D1-D4 are provided only by way of example, and that other values of one or more of D1-D4 may alternatively be used.

TABLE I

| Ion Mirror Operating | |
|---|---|
| Mode | Output Voltages (volts DC) |
| Transmission | V1: D1 = 0, D2 = 95, D3 = 135, D4 = 0 |
| | V2: D1 = 0, D2 = 95, D3 = 135, D4 = 0 |
| Reflection | V1: D1 = 190, D2 = 125, D3 = 135, D4 = 0 |
| | V2: D1 = 190, D2 = 125, D3 = 135, D4 = 0 |

While the ion mirrors M1, M2 and the charge detection cylinder CD are illustrated in FIGS. 1-2B as defining cylindrical passageways therethrough, it will be understood that in alternate embodiments either or both of the ion mirrors M1, M2 and/or the charge detection cylinder CD may define non-cylindrical passageways therethrough such that one or more of the passageway(s) through which the longitudinal axis 22 centrally passes represents a cross-sectional area and profile that is not circular. In still other embodiments, regardless of the shape of the cross-sectional profiles, the cross-sectional areas of the passageway defined through the ion mirror M1 may be different from the passageway defined through the ion mirror M2.

The voltage sources V1, V2 are illustratively controlled to selectively establish ion transmission and ion reflection electric fields in the region R1 of the ion mirror M1 and in the region R2 of the ion mirror M2 in a manner which allows ions to enter the ELIT 14 from the ion source 12, and which causes one or more ions to be selectively trapped within the ELIT 14 such that the trapped ion(s) repeatedly pass(es) through the charge detector CD as it/they oscillate(s) back and forth within the ELIT 14 between the ion mirrors M1 and M2. A charge induced on the charge detector CD each time an ion passes therethrough is detected by the charge sensitive amplifier CSA, and a corresponding charge detection signal (CHD) is produced by the charge sensitive amplifier CSA. The magnitude and timing of timing of the charge detection signal (CHD) produced by the charge sensitive amplifier CSA is illustratively a rounded square wave, and is recorded by the processor 16 for each charge detection event as this term is defined herein. Each charge detection event record illustratively includes an ion charge value, corresponding to a magnitude of the detected charge, and an oscillation period value, corresponding to the elapsed time between charge detection events, and each charge detection event record is stored by the processor 16 in the memory 18. The collection of charge detection events resulting from oscillation of ions back and forth through the charge detector CD a selected number of times or for a selected time period, i.e., making up an ion measurement event as this term is defined herein, are then processed to determine charge, mass-to-charge ratio and mass values of the ions.

A charged particle measurement process is illustratively executed by the processor 16 to process the time-domain ion measurement event data described above. In an embodiment of the charged particle measurement process, the ion measurement event data are processed by computing, with the processor 16, a Fourier Transform of the recorded collection of charge detection events. The processor 16 is illustratively operable to compute such a Fourier Transform using any conventional digital Fourier Transform (DFT) technique such as for example, but not limited to, a conventional Fast Fourier Transform (FFT) algorithm. In any case, the processor 16 is then illustratively operable to compute ion mass-to-charge ratio values (m/z), ion charge values (z), and ion mass values (m) of the ions, each as a function of the computed Fourier Transform. The processor 16 is illustratively operable to store the computed results in the memory 18 and/or to control one or more of the peripheral devices 20 to display the results for observation and/or further analysis.

It is generally understood that the mass-to-charge ratio (m/z) of an ion oscillating back and forth through the charge detector CD of an ELIT between opposing ion mirrors M1, M2 thereof is inversely proportional to the square of the fundamental frequency ff of the oscillating ion according to the equation:

$$m / z = C / {f𝔣}^{2} ,$$

where C is a constant that is a function of the ion energy and also a function of the dimensions of the respective ELIT, and the fundamental frequency ff is determined directly from the computed Fourier Transform. The value of the ion charge, z, is proportional to the magnitude FTMAG of the fundamental frequency ff, taking into account the number of ion oscillation cycles. In some cases, the magnitude(s) of one or more of the harmonic frequencies of the FFT may be added to the magnitude of the fundamental frequency for purposes of determining the ion charge, z. In any case, ion mass, m, is then calculated as a product of m/z and z. The processor 16 is thus operable to compute m/z=C/ff², z=F(FTMAG) and m=(m/z)(z). Multiple, e.g., hundreds or thousands or more, ion trapping events are typically carried out for any particular sample from which the ions are generated by the ion source 12, and ion mass-to-charge, ion charge, and ion mass values are determined/computed for each such ion trapping event. The ion mass-to-charge, ion charge, and ion mass values for such multiple ion trapping events are, in turn, combined to form spectral information relating to the sample. Such spectral information may illustratively take different forms, examples of which include, but are not limited to, ion count vs. mass-to-charge ratio, ion charge vs. ion mass (e.g., in the form of an ion charge/mass scatter plot), ion count vs. ion mass, ion count vs. ion charge, or the like.

Referring again to FIG. 1, and for purposes of the charge calibration process described below, the illustrated CDMS 10 further includes an antenna 24 mounted to, and electrically isolated from, the ground shield GC such that an electrically conductive portion 25 of the antenna 24 extends into the space 36 defined between the ground shield GC and the external surface of the charge detection cylinder CD. The antenna 24 is electrically connected to an output of an antenna voltage source VA1, and VA1 has an input electrically connected to an output of the processor 16. The antenna voltage source VA1 is responsive to a control signal C1 to produce and supply a voltage to the antenna 24. In some embodiments, the CDMS 10 may further include a second antenna 26 mounted to, and electrically isolated from the ground shield GC such that an electrically conductive portion 27 of the antenna 26 extends into the space 36 defined between the ground shield GC and the external surface of the charge detection cylinder CD. In embodiments which include the second antenna 26, the antenna 26 is illustratively connected electrically to an output of a second antenna voltage source VA2, and VA2 has an input electrically connected to another output of the processor 16 such the antenna voltage source VA2 is responsive to another control signal C2 to produce and supply a voltage to the antenna 26. In some alternate embodiments which include the antenna 26, the voltage source VA2 may be omitted, and the voltage source VA1 may be configured to be responsive to the control signals C1 and/or C2 to supply respective voltages to the antennas 24 and 26.

In the embodiment illustrated in FIG. 1, the voltage sources VA1 and VA2, in embodiments which include VA2, are configured to be responsive to the control signals C1 and C2 to respectively produce one or any combination of one or more DC voltages, voltage pulses, and/or voltage waveforms of any magnitude, shape, duration and/or frequency. The control signals C1 and C2 produced by the processor 16 may, in some embodiments, carry instructions to the voltage sources VA1 and VA2 to produce the one or more DC voltages, voltage pulses and/or voltage waveforms of any magnitude, shape, duration, and/or frequency. In alternate embodiments the voltage source VA1 and/or the voltage source VA2 may be programmable to produce the one or more DC voltages, voltage pulses, and/or voltage waveforms of any magnitude, shape, duration, and/or frequency, and in such embodiments the control signals C1 and C2 produced by the processor 16 may be trigger signals to which the respective voltage source VA1, VA2 is responsive to begin and stop producing respective output voltages.

The antenna 24, and the antenna 26 in embodiments which include it, operate according to a charge induction process in which charge is induced in the charge detection cylinder CD by the voltage applied to the antenna(s) 24 and/or 26. As the ground shield GC is generally maintained at ground potential and the charge detection cylinder CD is at or near ground potential when no charged particles are passing therethrough, the space 36 is substantially an electric field-free region. The voltage applied to the antenna 24 thus creates a voltage difference between the electrically conductive portion 25 of the antenna 24 and the charge detection cylinder CD, and the voltage applied to the antenna 26 likewise creates a voltage difference between the electrically conductive portion 27 of the antenna 26 and the charge detection cylinder CD. In either case, the voltage difference establishes a corresponding electric field between the antenna 24, or the antenna 26, and the charge detection cylinder CD, thus inducing a corresponding charge on the charge detection cylinder CD. The magnitude of the induced charge will generally be dependent upon the strength of the established electric field and thus upon the magnitude of the voltage applied by the voltage source VA1 or VA2 to the respective antenna 24 or 26.

### Charge Calibration Process

Prior to first use of the CDMS 10, and also potentially at other times as described below by example, calibration of the charged particle measurement process is undertaken to compensate for inconsistencies in the operation of the charge sensitive amplifier CSA, and to standardize the determined charge values of the charged particles to be measured by the CDMS 10. In an example embodiment, such a charge calibration process, which will be described more fully below, illustratively includes two calibration components; (A) calibration for variations in gain of the charge sensitive amplifier CSA, and (B) calibration for misalignment of charge determinations with integer charge states. In some embodiments, either A or B alone may form the charge calibration process. In any case, this charge calibration process may illustratively be conducted any time with the CDMS 10, without limitation, some examples of which may include, but are not limited to, periodically, at will, ad hoc, as part of initial set up or re-set up of the CDMS 10, in between uses of the CDMS 10 to measure different samples or sample types, or the like. The correction factor(s) resulting from the charge calibration process will be subsequently used in normal operation of the charge detection mass spectrometer to correct charge values of charged particles generated from a sample of interest and measured by the charge detection mass spectrometer.

### Calibration for CSA Gain Variations

The mass resolving power of the CDMS 10 depicted by example in FIG. 1 depends on the imprecision in both the m/z ratio and charge determinations for each ion. Because charge is quantized, it is only necessary in such embodiments to measure the charge accurately enough that the ion can be assigned to the correct charge state, which generally translates to an imprecision requirement in the charge measurements of <0.2 e (root mean square deviation). To achieve an imprecision of <0.2 e, it is desirable for the response of the charge sensitive amplifier CSA to be (i) stable over time, and (ii) linear with respect to oscillation frequency and signal amplitude.

With respect to criterion (i), any short- or long-term drift in the gain of the charge sensitive amplifier CSA is illustratively corrected according to an amplifier gain drift calibration process using dynamic calibration in which the processor 16 is configured to control the voltage source VA1 to produce and supply to the antenna 24 a constant amplitude, fixed frequency sine wave. In alternate embodiments, the voltage may have other shapes, e.g., square wave, triangular wave, etc. The fixed frequency value may be any frequency, without limitation, and may illustratively be any frequency within the range of typical oscillation frequencies of charged particles within the ELIT 14 during normal operation of the CDMS 10 (i.e., to analyze samples).

The amplifier gain drift calibration process is illustratively an iterative process which is continually or periodically executed to monitor, track, and correct for CSA gain drift over time. In this regard, in the first execution of the amplifier gain drift process, i.e., upon installation of a new charge sensitive amplifier CSA and/or at initial setup of the CDMS 10, the processor 16 is illustratively operable to compute FFTs of the charge signals induced on the charge detection cylinder CD and detected by the charge sensitive amplifier CSA (in the form of the charge signal CH described above) in response to application of the constant amplitude, fixed frequency sine wave, and to store the magnitudes, or averages of the magnitudes, of at least the fundamental frequencies of the FFTs in the memory 18. At each following execution of the amplifier gain drift calibration process, the processor 16 is illustratively operable to compute FFTs of the charge signals induced on the charge detection cylinder CD and detected by the charge sensitive amplifier CSA (in the form of the charge signal CH described above) in response to the constant amplitude, fixed frequency sine wave, to compare the magnitudes, or averages of the magnitudes, of at least the fundamental frequencies of the FFTs to the stored values from the most recent execution of the amplifier gain drift process, and to determine or update a charge magnitude correction factor CG based on differences therebetween. In this manner, the charge magnitude correction factor CG will be continually or periodically updated to correspond to the drift in CSA gain over time. The charge magnitude correction factor CG will then be used during normal operation of the CDMS 10 (i.e., to analyze samples as described above) to correct the magnitudes of FFTs of time-domain charge detection signals CHD. As amplifier gain variation over time is dynamic, it will be understood that execution of the amplifier gain drift calibration process will not be limited to the charge calibration process here described, but will typically be a process that is continually or periodically executed during the operation of the CDMS 10, e.g., between charge detection events, between ion measurement events, and/or periodically but with greater frequency than the charge calibration process here described, so as to correct the magnitudes of FFTs of time-domain charge detection event data and/or ion measurement event data resulting from drift of the CSA gain over time.

With respect to criterion (ii) of the CSA gain variation calibration process, the gain of the charge sensitive amplifier CSA may show a frequency dependence. Typically, the CSA gain rolls off significantly at both high and low frequencies (e.g., typically above 20 kHz and below 20 Hz), but may also exhibit non-linearities at frequencies therebetween. To correct for any such frequency dependent non-linearity in the gain of the charge sensitive amplifier CSA, the processor 16 is illustratively configured to execute an amplifier frequency dependent gain variation calibration process by controlling the voltage source VA2 to produce and supply to the antenna 26 a constant amplitude square wave signal over a range of frequencies. In alternate embodiments, this frequency-dependent amplifier gain variation calibration process may be carried out using the same antenna 24 and voltage source VA1 used for the amplifier gain drift calibration process just described, and in such embodiments the antenna 26 and the voltage source VA2 may therefore be omitted. In any case, the processor 16 is illustratively operable to compute FFTs of the resulting charge signals induced on the charge detection cylinder CD and detected by the charge sensitive amplifier CSA (in the form of the charge signal CH described above), and the magnitudes of the FFTs over the range of frequencies are illustratively corrected using the correction factor CG of the dynamic amplifier gain drift calibration process just described. In this manner, the amplifier frequency dependent gain variation calibration process includes and incorporates the amplifier gain drift calibration process described above. In some embodiments, the range of frequencies of the voltage signal applied to the antenna 26 may be selected to include all or most potential oscillation frequencies of charged particles to be subsequently analyzed by the CDMS 10. One such example range of frequencies may be, but is not limited to, 3 kHz-50 (or 60) kHz, although other frequency ranges are contemplated. In other embodiments, the range of frequencies of the voltage signal applied to the antenna 26 may be selected to match or include the range of expected oscillation frequencies of charged particles to be subsequently analyzed by the CDMS 10, wherein the range of expected oscillation frequencies may be sample dependent, i.e., may depend on the sample being analyzed by the CDMS 10.

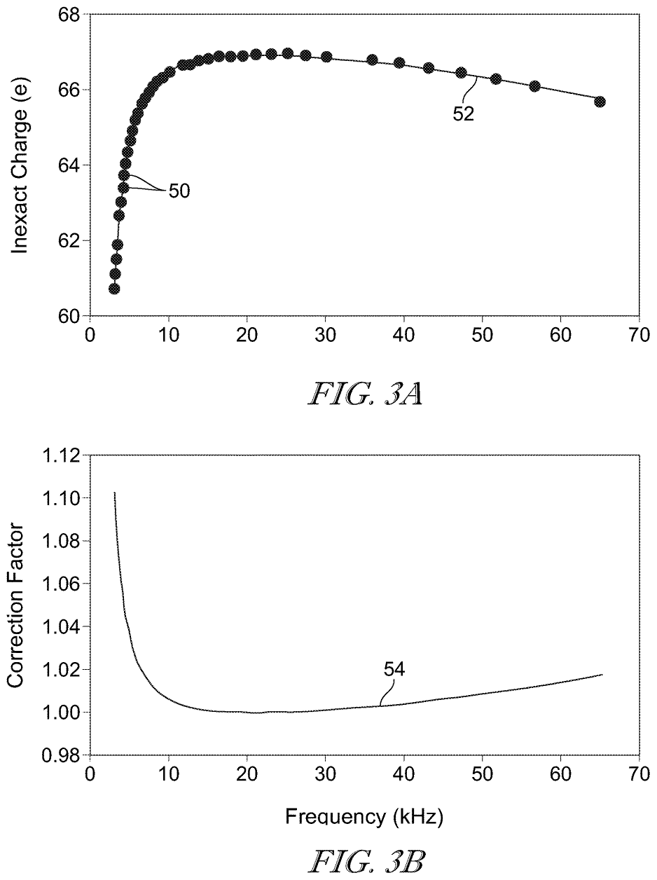

The charges induced on the charge detection cylinder CD over the range of frequencies by the voltage signal applied to the antenna 26 are first estimated using a calculated capacitance between the antenna 26 and the charge detection cylinder CD. Illustratively, the capacitance between the antenna 26 and the charge detection cylinder CD may be calculated in a conventional manner using known mathematical relationships. The estimated induced charges are then used by the processor 16 to determine and provide an approximate conversion factor to convert the average magnitude from the FFT analysis into an “inexact charge.” It will be understood that the term “inexact charge” is used here to characterize the charge values at this point in the calibration process because the charge values are calibrated only using the calculated capacitance between the antenna 26 and charge detection cylinder CD, and further correction is required to generate accurate charge values as will be described below. A plot of inexact charges 50 against frequency is generated by the processor 16, and illustrated by example in FIG. 3A. The inexact charge data 50 are then illustratively fit by the processor 16 with a function 52 that can be used to correct for variations in response of the charge sensitive amplifier with frequency. In the example plot of FIG. 3A, the function 52 is illustratively a least squares fit to the following function:

$${Q}_{ix} ( f ) = {A}_{1} + \frac{{A}_{2}}{{f}^{2}} + {A}_{3} {f}^{2} + {A}_{4} {f}^{4} \qquad ( 1 )$$

where A₁, A₂, A₃, and A₄ are constants determined by the fit, Qᵢₓ is the inexact charge, and f is the frequency. To determine a frequency dependent correction factor C(f), the derivative of equation 1 is set to zero to determine the maximum value of the inexact charge,

$${Q}_{ix}^{max} ,$$

and the correction factor C(f) is then given by

$$C ( f ) = \frac{{Q}_{ix}^{max}}{{Q}_{ix} ( f )} \qquad ( 2 )$$

Using equations 1 and 2, the frequency-dependent correction factor 54 for the inexact charge data of FIG. 3A is plotted in FIG. 3B.

Following the charge calibration process described herein, and during subsequent operation of the CDMS 10 to analyze samples as described with respect to FIG. 1, the magnitudes of the FFTs resulting from measurement by the CDMS 10 of charged particles generated from a sample of interest are corrected by the correction factor C(f) resulting from the amplifier frequency dependent gain variation calibration process, and also by the correction factor CG of the amplifier gain drift calibration process as described above.

Calibration for Misalignment of Charge Determinations with Integer Charge States

After correction for the CSA gain drift and frequency dependence, the next task of the charge calibration process is to correct misalignment of the charge determinations with integer charge states. In this regard, m/z and charge values are illustratively measured for a wide range of samples, examples of which may include, but are not limited to, ubiquitin, monoclonal antibody MSQC4, Glutamate Dehydrogenase (GDH), and hepatitis B virus (HBV) virus like particles (VLPs).

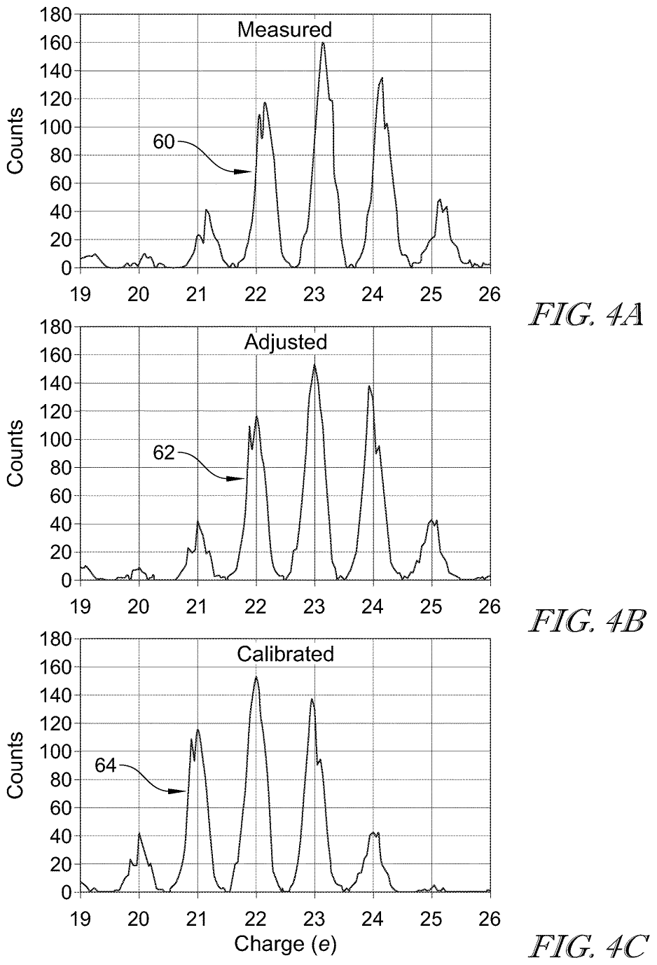

It is desirable for the charges used for this aspect of the calibration process to be measured with a charge RMSD of <0.2 e, where the charge states in the charge spectrum are well resolved, and an example of such a well resolved charge spectrum is shown in FIG. 4A which depicts an uncalibrated charge spectrum 60 measured for mAb MSQC4. If, however, the charges are not well resolved in the charge spectrum, but they are well resolved in the m/z spectrum, then the ions contributing to each m/z charge state can be separated and their average measured charge determined. In either case, the individual charge values (for resolved charge states) or average charge values (for resolved m/z charge states) may not initially align well with integer charge states. An example of this is evident in FIG. 4A in which the peaks of the measured charges do not align with integer charge states along the charge axis, but rather occur between integer charge states. To correct for this discrepancy, the measured charges are corrected using the equation

$${q}_{adj} = {b}_{1} {q}_{meas} + {b}_{0} \qquad ( 3 )$$

where qₘₑₐₛ is the measured charge value and q_{adj} is the adjusted charge value. In one embodiment, b₁ and bₒ in equation 3 are both constants that are determined by minimizing the variance

$$V = \sum {( {q}_{adj} - INT ( {q}_{adj} ) )}^{2} / n \qquad ( 4 )$$

where INT(q_{adj}) returns the nearest integer to q_{adj}. In equation 3, b₀ is an offset in the measured charge values that results from electrical noise, and b₁ is a linear correction to the amplifier response that ensures that the adjusted charge values align with integer charge states over a wide range of charges. FIG. 4B shows an adjusted charge state distribution 62, which is the charge state distribution 60 of FIG. 4A after correction of the charge scale using equations 2 and 4, and in which the peaks of the adjusted charges now align with the integer values. However, although the peaks of the adjusted charges now align with respective integer values, there is no guarantee at this point that the peaks of the adjusted charges are aligned with the correct integer charge states since the variance (equation 4) has the same value for b₀ and b₀±1, b₀±2, etc.

One example technique for ensuring that the peaks of the adjusted charges are assigned to the correct integer charge state is to compare the measured and expected masses. When making this comparison it is necessary to bear in mind that the measured mass could be larger than the expected mass because of salt adducts. The deviation is typically less than 1%. In the case of relatively small ions like mAb MSQC4, the mass shifts by around 4.5% per integer charge if the ions are assigned to the wrong integer charge state. In this example, a comparison of the measured and expected masses shows that the peaks of the charges in FIG. 4A are all one integer charge too large. A calibrated charge distribution 64, after subtracting 1 e (elementary charge) from all of the charges in the adjusted charge distribution 62, is shown in FIG. 4C.

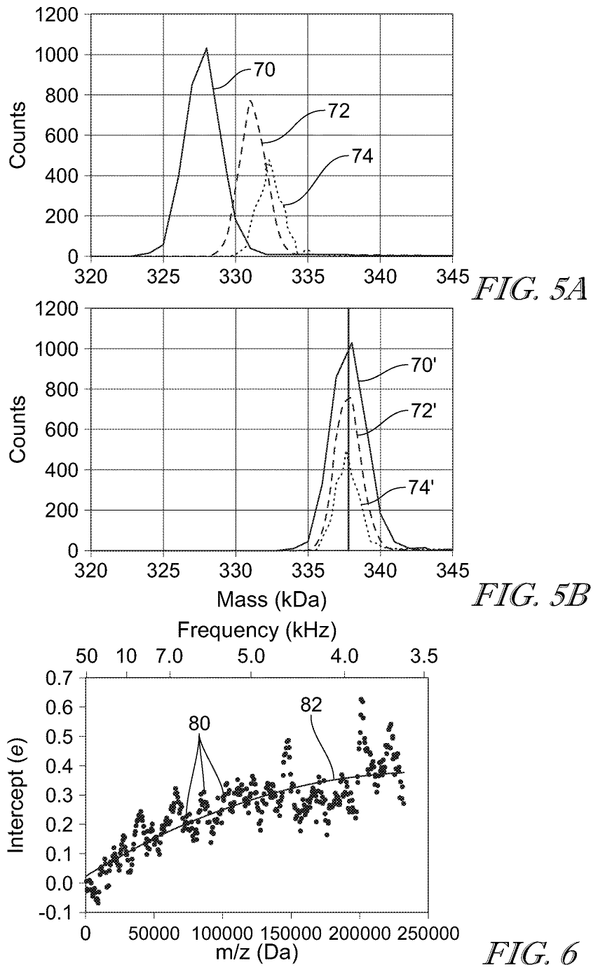

For larger, more highly charged ions, the mass shift with addition or subtraction of an integer charge is smaller, and the uncertainty in the expected mass is larger (due to post translational modifications, as well as salt adducts). In these cases, another check is conducted to ensure that the charge states are correctly assigned. For high mass ions, multimers (dimers, trimers, etc.) are usually prominent and the comparison of the measured masses of the monomer, and multimers provides a useful way to ensure that the charges are correctly assigned. It is generally understood that the masses of the dimers are generally equal to two times the mass of the monomer (or very slightly larger), and the mass of the trimer are generally three times the monomer mass (or very slightly larger), and this calibration technique is illustrated by example in FIGS. 5A and 5B. FIG. 5A shows a mass distribution 70 measured for glutamate dehydrogenation (GDH) is shown by the solid line. The mass distribution 72 measured for the dimer (masses divided by 2) is shown by the dashed line, and the mass distribution 74 for the trimer (masses divided by 3) is shown by the dotted line. As depicted in FIG. 5A, the masses for the monomer, dimer and trimer do not align with one another, indicating that the integer charge states are misassigned. FIG. 5B shows the corrected mass distributions 70′, 72′, 74′ after adding one integer charge to all of the charges. The masses of the monomer, dimer, and trimer now align, indicating that the charge assignments are now correct.

### Alternate Embodiment of Calibration for Charge Determination Misalignment

Electrical noise is expected to lead to a positive offset in the magnitudes derived from FFT analysis of the time domain data, and hence a positive offset in the charge values determined from the magnitudes. This is the main origin of the charge offset b₀ in equation 3 above. Such electrical noise is, however, frequency dependent and has a substantial 1/f component, therefore leading to an expectation that the electrical noise will increase at lower oscillation frequencies. Thus, rather than treating the charge offset b₀ as a constant as in the embodiment described above, the charge offset b₀ in this alternate embodiment is determined as a function of frequency.

To determine the size of the charge offset b₀, the processor 16 is illustratively operable to control the voltage source VA2 to apply to the antenna 26 a voltage signal in the form of fixed frequency signals with a range of amplitudes that covers the range of input charges of interest. In some alternative embodiments, the processor 16 may instead control the voltage source VA1 to apply the fixed frequency signals to the antenna 24, and in some such embodiments the antenna 26 and the voltage source VA2 may therefore be omitted. In any case, the processor 16 is illustratively operable to compute FFTs of the resulting time domain charge signals induced on the charge detection cylinder CD and detected by the charge sensitive amplifier CSA (in the form of the charge signal CH described above), and the average charges from the FFTs are plotted as a function of charge expected from the signal applied to the antenna 26. The results are then fit with the following function using a least squares criteria:

$${Q}_{FFT} = {a}_{0} + {a}_{1} {Q}_{SA} \qquad ( 5 )$$

where QF_{FT} is the average charge determined from the FFT analysis, Q_{SA} is the expected charge calculated from the amplitude of the square wave signal applied to the antenna and the calculated capacitance between the antenna 26 and the charge detection cylinder CD as described above. In equation 5, it is assumed that the response of the charge sensitive amplifier CSA is linear with a non-zero intercept (a₀). The slope of the line (a₁) is expected to be close to 1.000. Since the charge offset b₀ due to electrical noise is expected to be frequency dependent, the measurements here should be performed as a function of frequency and the resulting offsets fit to a function so that the offset can be determined and subtracted from the magnitudes obtained for any frequency.

An example is shown in FIG. 6 which shows the intercepts (a₀) are plotted against m/z. As described above with respect to FIGS. 1, 2A, and 2B, the m/z of an ion trapped in the ELIT 14 is determined from the ion's oscillation frequency using the following equation:

$$\frac{m}{z} = \frac{C}{{f}^{2}} \qquad ( 6 )$$

where C is a constant that depends on the ion energy and ELIT geometry. The labels on the top axis in FIG. 6 show some of the frequencies that correspond to the m/z scale. The points 80 in FIG. 6 are the intercepts (a₀) determined from the measurements, and the line 82 extending through the points 80 is a polynomial fit that that can be used to determine the offset for any m/z or frequency within the range shown in the plot. As expected, the noise increases at lower frequencies (higher m/z).

The slopes (a₁) from the fits given by equation 5 represent the frequency dependence of the amplifier response, i.e., the same information that is shown in FIG. 3A for a single input charge. The difference between the results in FIG. 3A and the slopes determined here is that the small frequency dependent offsets are not removed from the data in FIGS. 3A and 3B. The offsets are removed later in the analysis when the measured charges are calibrated in according to equations 3 and 5 above. This alternative embodiment which incorporates a frequency dependent offset is superior to the embodiment described above. The frequency-dependent slopes can be treated in the same way as the frequency dependent gains in the previous section to determine a function to correct the charge values for the frequency dependence of the response of the charge sensitive amplifier CSA.

The correction procedure may be further refined to correct for any small non-linearities in the response of the charge sensitive amplifier CSA with regard to input signal. To this point it has been assumed that the response of the charge sensitive amplifier CSA is linear (except for the small offset). The charge range of interest extends from a single charge up to over 10,000 e, and small non-linearities in the gain of the charge sensitive amplifier over this wide range may influence the results. The non-linearities may be accounted for by expanding equation 5 to include higher order terms such as a polynomial, e.g., of the form:

$${Q}_{FFT} = {a}_{0} + {a}_{1} {Q}_{SA} + {a}_{2} {Q}_{SA}^{2} + … \qquad ( 7 )$$

or some other global function. Alternatively, a two-dimensional interpolation could be performed for the results as a function of frequency and charge. Following the procedures outlined in this section, the corrected charges must be calibrated to charges measured for ions as outlined above.

### Post Calibration Corrections to Charge Values

Even with a near perfect calibration of the frequency and charge dependences of the gain of the charge sensitive amplifier CSA, day to day variations in the instrument performance may lead to small deviations in the charge values. Thus, the measured charges may not align perfectly with integer charge states. If the charges are not correctly aligned, some of the ions may be assigned to the wrong charge state, which would affect the mass distributions determined by the CDMS 10. Such small deviations may be corrected, for example, using the following function

$${q}_{corr} = {c}_{1} {q}_{calib} + {c}_{0} \qquad ( 8 )$$

wherein c₁ and c₀ are constants that are determined by minimizing the

$$V = \sum {( {q}_{corr} - INT ( {q}_{corr} ) )}^{2} / n . \qquad ( 9 )$$

q_{corr} is the corrected charge and q_{calib} is the calibrated charge that is not perfectly aligned with integer charge states.

### Alternate Embodiment With Orbitrap DMT

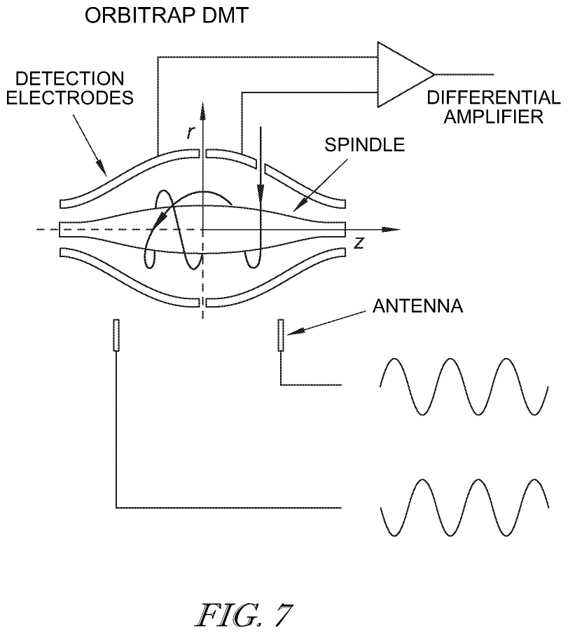

Orbitrap DMT (direct mass technology) is an alternative approach to performing single ion mass measurements. This approach is implemented on commercial Orbitrap instruments where the signal is detected using two detection electrodes and a differential amplifier. The same approach outlined above also applies to this platform and the frequency dependent noise offset and frequency response of the amplifier can be corrected in the same way. However, the Orbitrap uses a differential amplifier to detect the signals from the oscillating ions as shown by example in FIG. 7. Because there are two detection electrodes and a differential amplifier there must be at least two antennae, one for each detection electrode, and the antennae should be supplied with signals that are 180° out of phase (as also illustrated in FIG. 7). The strategy outlined above to correct for the drift in the amplifier response over time can also be implemented on the Orbitrap DMT platform.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, it will be understood that the ELIT 14 illustrated in the attached figures and described herein is provided only by way of example, and that the concepts, structures and techniques described above may be implemented directly in ELITs of various alternate designs. Any such alternate ELIT design may, for example, include any one or combination of two or more ELIT regions, more, fewer and/or differently-shaped ion mirror electrodes, more or fewer voltage sources, more or fewer DC or time-varying signals produced by one or more of the voltage sources, one or more ion mirrors defining additional electric field regions, or the like. As another example, while the concepts, structures and/or techniques of this disclosure have been described as being implemented in an electrostatic linear ion trap (ELIT), it will be understood that such concepts, structures and/or techniques are not intended to be limited to ELITs or variants thereof, but rather are intended to be applicable to any conventional charge detector or charge detection apparatus. Accordingly, any conventional charge detector or charge detection apparatus implementing the concepts, structures and/or techniques illustrated in the attached figures and described herein are intended to fall within the scope of this disclosure.

What is claimed is:

1. A method of calibrating charge values of charged particles to be measured by charge detection mass spectrometer, the charge detection mass spectrometer including a charge detection cylinder, a charge sensitive amplifier to detect charges induced on the charge detection cylinder, and at least one antenna for inducing charges on the charge detection cylinder, the method comprising:
applying a constant amplitude, variable frequency signal to the at least one antenna to induce respectively constant amplitude charges on the charge detection cylinder over a range of frequencies, and
processing charge detection signals produced by the charge sensitive amplifier in response to detection of the constant amplitude charges induced on the charge detection cylinder over the range of frequencies to determine a frequency-dependent correction factor to apply to and calibrate the charge values of charged particles to be measured by the charge detection mass spectrometer.

2. The method of claim 1, wherein the charge detection mass spectrometer includes a charged particle generator to generate charged particles from a sample, and further comprising:
measuring, with the charge detection mass spectrometer, mass-to-charge and charge values of charges induced on the charge detection cylinder by charged particles generated by the charged particle generator from a number of different sample species, and
processing charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

3. The method of claim 1, further comprising, prior to applying the constant amplitude, variable frequency signal to the at least one antenna:
applying a constant amplitude, fixed frequency signal to the at least one antenna to induce respectively constant amplitude, fixed frequency charges on the charge detection cylinder, and
processing charge detection signals produced by the charge sensitive amplifier in response to detection of the constant amplitude, fixed frequency charges induced on the charge detection cylinder to determine a magnitude correction factor to apply to and calibrate the charge values of charged particles to be measured by the charge detection mass spectrometer.

4. The method of claim 3, further comprising:
prior to determining the frequency-dependent correction factor, correcting magnitudes of the charge detection signals produced by the charge sensitive amplifier in response to detection of the constant amplitude charges induced on the charge detection cylinder over the range of frequencies using the magnitude correction factor.

5. The method of claim 2, wherein the alignment correction factor includes a linear correction component dependent on the measured mass-to-charge and charge values of the charged particles for the number of different sample species, and an offset correction component.

6. The method of claim 5, wherein the offset correction component is a constant.

7. The method of claim 5, further comprising:
applying a constant frequency, variable amplitude signal to the at least one antenna to induce respectively constant frequency charges on the charge detection cylinder over a range of amplitudes, and
processing charge detection signals produced by the charge sensitive amplifier in response to detection of the constant frequency charges induced on the charge detection cylinder over the range of amplitudes to determine the offset correction component in the form of an amplitude-dependent correction factor.

8. A method of calibrating charge values of charged particles to be measured by charge detection mass spectrometer, the charge detection mass spectrometer including a charged particle generator to generate charged particles from a sample, a charge detection cylinder, and a charge sensitive amplifier to detect charges induced on the charge detection cylinder, the method comprising:
measuring, with the charge detection mass spectrometer, mass-to-charge and charge values of charges induced on the charge detection cylinder by charged particles generated by the charged particle generator from a number of different sample species, and
processing charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

9. The method of claim 8, wherein the alignment correction factor includes a linear correction component dependent on the measured mass-to-charge and charge values of the charged particles for the number of different sample species, and an offset correction component.

10. The method of claim 9, wherein the offset correction component is a constant.

11. The method of claim 9, wherein the charge detection mass spectrometer includes at least one antenna for inducing charges on the charge detection cylinder, and further comprising:
applying a constant frequency, variable amplitude signal to the at least one antenna to induce respectively constant frequency charges on the charge detection cylinder over a range of amplitudes, and
processing charge detection signals produced by the charge sensitive amplifier in response to detection of the constant frequency charges induced on the charge detection cylinder over the range of amplitudes to determine the offset correction component in the form of an amplitude-dependent correction factor.

12. A charge detection mass spectrometer, comprising:
an electrostatic linear ion trap (ELIT) or an orbitrap, including a charge detection cylinder,
a charge sensitive amplifier configured to detect charges induced on the charge detection cylinder,
at least one antenna for inducing charges on the charge detection cylinder,
at least one voltage source,
at least one memory, and
at least one processor configured to execute instructions stored in the at least one memory to cause the at least one processor to calibrate charge values of charged particles to be measured by the charge detection mass spectrometer by (i) controlling the at least one voltage source to apply a constant amplitude, variable frequency signal to the at least one antenna to induce respectively constant amplitude charges on the charge detection cylinder over a range of frequencies, and (ii) processing charge detection signals produced by the charge sensitive amplifier in response to detection of the constant amplitude charges induced on the charge detection cylinder over the range of frequencies to determine a frequency-dependent correction factor to apply to and calibrate the charge values of charged particles measured by the charge detection mass spectrometer.

13. The charge detection mass spectrometer of claim 12, further comprising a charged particle generator to generate charged particles and to supply the generated charged particles to the ELIT or orbitrap,
wherein the instructions stored in the memory include instructions executable by the at least one processor to cause the at least one processor to (iii) control the charge detection mass spectrometer to measure mass-to-charge and charge values of charges induced on the charge detection cylinder by charged particles generated by the charged particle generator from a number of different sample species, and (iv) to process charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

14. The charge detection mass spectrometer of claim 12, wherein the instructions stored in the memory further include instructions executable by the at least one processor to cause the at least one processor to, prior to controlling the at least one voltage source to apply the constant amplitude, variable frequency signal to the at least one antenna, (v) control the at least one voltage source to apply to the at least one antenna a constant amplitude, fixed frequency signal to the at least one antenna to induce respectively constant amplitude, fixed frequency charges on the charge detection cylinder, and (vi) process charge detection signals produced by the charge sensitive amplifier in response to detection of the constant amplitude, fixed frequency charges induced on the charge detection cylinder to determine a magnitude correction factor to apply to and calibrate the charge values of charged particles to be measured by the charge detection mass spectrometer.

15. The charge detection mass spectrometer of claim 14, wherein the instructions stored in the memory further include instructions executable by the at least one processor to cause the at least one processor to, prior to determining the frequency-dependent correction factor, correct magnitudes of the charge detection signals produced by the charge sensitive amplifier in response to detection of the constant amplitude charges induced on the charge detection cylinder over the range of frequencies using the magnitude correction factor.

16. The charge detection mass spectrometer of claim 13, wherein the alignment correction factor comprises a linear correction component dependent on the measured mass-to-charge and charge values of the charged particles for the number of different sample species, and an offset correction component,
and wherein (vii) the offset correction component is a constant, or (viii) the instructions stored in the memory further include instructions executable by the at least one processor to cause the at least one processor to (ix) control the at least one voltage source to apply a constant frequency, variable amplitude signal to the at least one antenna to induce respectively constant frequency charges on the charge detection cylinder over a range of amplitudes, and (x) process charge detection signals produced by the charge sensitive amplifier in response to detection of the constant frequency charges induced on the charge detection cylinder over the range of amplitudes to determine the offset correction component in the form of an amplitude-dependent correction factor.

17. The charge detection mass spectrometer of claim 13, further comprising at least one ion processing stage positioned between the charged particle generator and the ELIT or orbitrap.

18. The charge detection mass spectrometer of claim 13, wherein the charged particle generator is an electrospray ionization source.

19. A charge detection mass spectrometer, comprising:
an electrostatic linear ion trap (ELIT) or an orbitrap, including a charge detection cylinder,
a charged particle generator to generate charged particles and to supply the generated charged particles to the ELIT or orbitrap,
at least one memory, and
at least one processor configured to execute instructions stored in the at least one memory to cause the at least one processor to calibrate charge values of charged particles to be measured by the charge detection mass spectrometer by (i) controlling the charge detection mass spectrometer to measure mass-to-charge and charge values of charges induced on the charge detection cylinder by charged particles generated by the charged particle generator from a number of different sample species, and (ii) to process charge detection signals produced by the charge sensitive amplifier in response to the measured mass-to-charge and charge values of the charged particles for the number of different sample species to determine an alignment correction factor, in which the measured charge values of charged particles generated from the number of different sample species align with integer charge values, to apply to and calibrate the charge values of charged particles to be measured by the charge detection mass spectrometer.

20. The charge detection mass spectrometer of claim 19, further comprising a charge sensitive amplifier configured to detect charges induced on the charge detection cylinder, at least one antenna for inducing charges on the charge detection cylinder, and at least one voltage source,
wherein the alignment correction factor comprises a linear correction component dependent on the measured mass-to-charge and charge values of the charged particles for the number of different sample species, and an offset correction component,
and wherein (iii) the offset correction component is a constant, or (iv) the instructions stored in the memory further include instructions executable by the at least one processor to cause the at least one processor to (v) control the at least one voltage source to apply a constant frequency, variable amplitude signal to the at least one antenna to induce respectively constant frequency charges on the charge detection cylinder over a range of amplitudes, and (vi) process charge detection signals produced by the charge sensitive amplifier in response to detection of the constant frequency charges induced on the charge detection cylinder over the range of amplitudes to determine the offset correction component in the form of an amplitude-dependent correction factor.
